(19) United States
(12) Patent Application Publication
(10) Pub. No.: US 2002/0107690 A1
(43) Pub. Date: Aug. 8, 2002

(54) Speech dialogue system

(76) Inventor: Bernd Souvignier, Aachen (DE)

Correspondence Address: Corporate Patent Counsel, U.S. Philips Corporation, 580 White Plains Road, Tarrytown, NY, 10591, US

(21) Appl. No.: 09/944,300

(22) Filed: Aug. 31, 2001

(30) Foreign Application Priority Data
Sep. 5, 2000 (DE) 10043531.9

(51) Int. Cl. G10L 15/04

(52) U.S. Cl. 704/251

(57) ABSTRACT

The invention relates to a speech dialogue system (1). To guarantee a maximum reliable identification of meaningful word sub-sequences for a broad spectrum of formulation alternatives with speech inputs, the speech dialogue system comprises a speech understanding unit (4) in which an evaluation of the word sub-sequence is effected with different speech models (8) for identifying a meaningful word sub-sequence from a recognition result produced by a speech recognition unit (3) which was determined for a word sequence fed to the speech dialogue system (1).

### The invention relates to a speech dialogue system, for example, an automatic information system.

Such a dialogue system is known from A. Kellner, B. Rüber, F. Seide and B. H. Tran, “PADIS—AN AUTOMATIC TELEPHONE SWITCH BOARD AND DIRECTORY INFORMATION SYSTEM”; Speech Communication, vol. 23, pp. 95-111, 1997. A user's speech utterances are received here via an interface to a telephone network. As a reaction to a speech input a system response (speech output) is generated by the dialogue system, which speech output is transmitted to the user via the interface and here further via the telephone network. A speech recognition unit based on Hidden Markov Models (HMM) converts speech inputs into a word graph, which indicates various word sequences in compressed form, which are eligible as a recognition result for the received speech utterance. The word graph defines fixed word boundaries which are connected by one or various arcs. To an arc is respectively assigned a word and a probability value determined by the speech recognition unit. The various paths through the word graphs represent the possible alternatives for the recognition result. In a speech understanding unit the information relevant to the application is determined by a processing of the word graph. For this purpose a grammar is used, which contains syntactic and semantic rules. The various word sequences resulting from the word graph are converted to concept sequences by means of a parser using the grammar, while a concept stretches out over one or various words of the word path and combines a word sub-sequence (word phrase) which carries information relevant to the respective use of the dialogue system or, in the case of a so-called FILLER concept, represents a word sub-sequence which is meaningless for the respective application. The concept sequences resulting thus are finally converted into a concept graph to have the possible concept sequences available in compressed form, which is also easy for processing. To the arcs of the concept graph are in their turn assigned probability values which depend on the associated probability values of the word graph. From the optimal path through the concept graph are finally extracted the application-relevant semantic information signals, which are represented by so-called attributes in the semantic rules of the grammar. A dialogue control unit evaluates the information determined by the speech interpreting unit and generates a suitable response to the user while the dialogue control unit accesses a database containing application-specific data (here: specific data for the telephone inquiry application).

Such dialogue systems can also be used, for example, for railway information systems, where only the grammar and the application-specific data in the database are to be adapted. Such a dialogue system is described in H. Aust, M. Oerder, F. Seide, V. Steinbiβ, “A SPOKEN LANGUAGE INQUIRY SYSTEM FOR AUTOMATIC TRAIN TIMETABLE INFORMATION”, Philips J. Res. 49 (1995), pp. 399-418.

In such a system a grammar derives, for example, from a word sub-sequence “at ten thirty” the associated semantic information “630 minutes after midnight” in the following fashion, while a syntactic and a semantic rule are applied as follows: <time of day>::=<number_{—}24>hour<number₁₃60>(syntactic rule) <time of day>.val:=60*<number_{—}24>.val+<number_{—}60>.val (semantic rule).

<Number_{—}24>stands for all the numbers between 0 and 24 and <number_{—}60>for all numbers between 0 and 60; the two parameters are so-called non-terminal parameters of a hierarchically structured grammar. The associated semantic information is represented by the attributes <number_{—}24>.val and <number_{—}60>.val to which the associated number values are assigned for calculating the sought time of day.

This approach works very well when the structure of the information carrying formulations are known a priori thus, for example, for times of day, dates, place names or names of persons from a fixed list of names. However, this approach fails when information is formulated more freely. This may be clarified with the following example in which the speech dialogue system is used in the field of cinema information:

The official title of a James Bond film of 1999 is “James Bond—The world is not enough”. Typical questions about this film are “the new Bond”, “the world is not enough” or “the latest film with Pierce Brosnan as James Bond”. The possible formulations can hardly be foreseen and depend on the currently running films which change every week. By fixed rules in a grammar it is possible to identify only one or several of this multitude of formulations, which occur as word sub-sequences in speech inputs and in the recognition results produced by the speech recognition unit of the dialogue system. Without additional measures this leads to a plurality of formulation variants, which are not covered by the grammar used, not identified and thus cannot be interpreted by the assignment of semantic information either.

It is an object of the invention to provide a dialogue system which guarantees a maximum reliable identification of respective word sub-sequences for a broad spectrum of formulation alternatives in speech inputs.

The object is achieved by a dialogue system in accordance with patent claim 1.

With this dialogue system, significant word sub-sequences of a recognition result produced by the speech recognition unit (which result particularly occurs as a word graph or N best word sequence hypotheses) can be identified with great reliability even when a multitude of formulation variants occurs whose syntactic structures are not known a priori to the dialogue system and therefore cannot explicitly be included in the grammar used. The identification of such a word sub-sequence is successful in that such an evaluation takes place by means of competing speech models (for example, bigram or trigram speech models), which are trained to different (text) corpora. Preferably, a general and at least a theme-specific speech model are used. A general speech model is trained, for example, to a training corpus formed by articles from daily newspapers. For example, for theme-specific speech models for the application to cinema information are used a speech model for film title information and a speech model for the information regarding the contents of the film (for example, names of actors). As a training corpus for the film title speech model may then be used the composition of the title of the currently running films. As a training corpus for the speech model for film contents may then be used the composition of short descriptions of these films. If one speech model compared to the other speech models is thematically nearer to a (freely formulated) word sub-sequence, such a speech model will assign a higher probability to this word sub-sequence than the other speech models, in particular higher than a general speech model (compare claim 2); this is used for identifying the word sub-sequence as being meaningful.

With the invention the grammar-defined connection between the identification and interpretation of a word sub-sequence in previous dialogue systems is eliminated. Claim 3 indicates how semantic information can be assigned to the identified word sub-sequences. Since these word sub-sequences are not explicitly included by the grammar of the dialogue system, special measures can be taken in this respect. It is suggested to access databases having respective theme-specific data material. An identified word sub-sequence is compared with the database items and the database item (possibly with a plurality of assigned data fields) resembling the identified word sub-sequence the most is used for determining the semantic information of the identified word sub-sequence, for example, by assigning the values of one or a plurality of data fields of the selected database item.

claim 4 describes a method developed for identifying a significant word sub-sequence.

Examples of embodiment of the invention will be further explained hereinafter with reference to the drawings, in which:

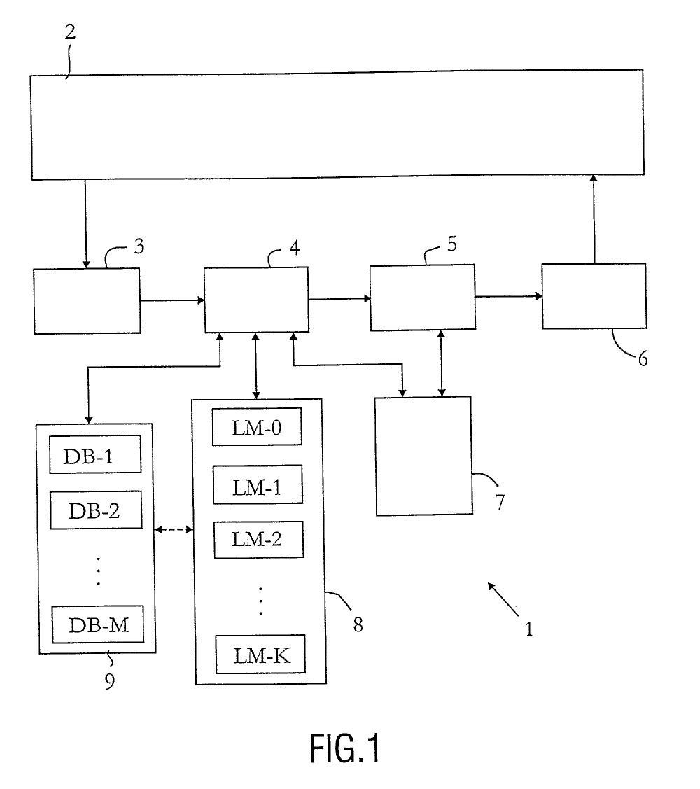

FIG. 1 shows a block diagram of a speech dialogue system,

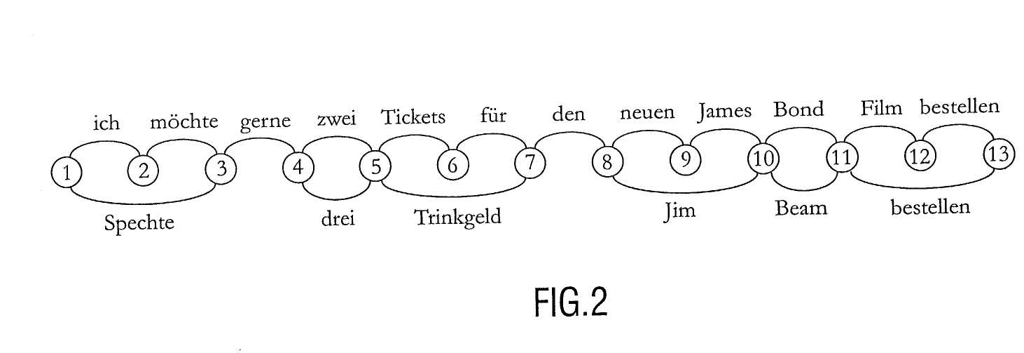

FIG. 2 shows a word graph produced by a speech recognition unit of the speech dialogue system, and

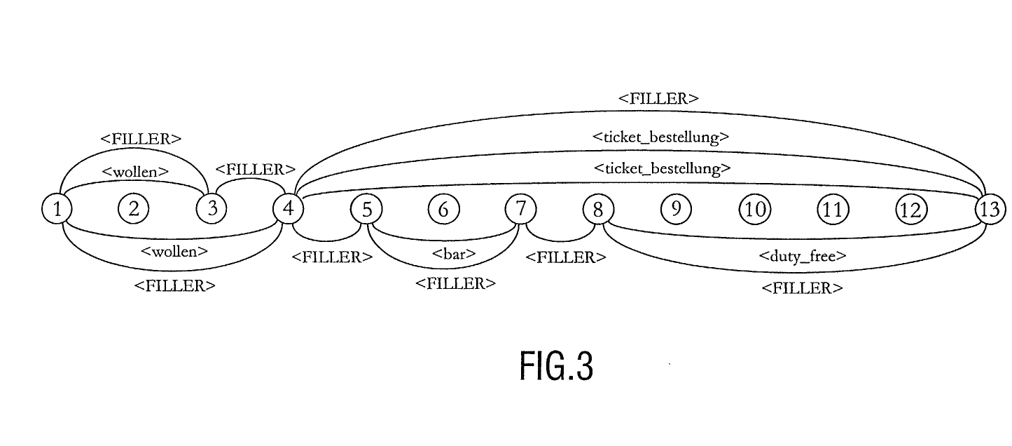

FIG. 3 shows a concept graph generated in a speech interpreting unit of the speech dialogue system.

FIG. 1 shows a speech dialogue system 1 (here: cinema information system) with an interface 2, a speech recognition unit 3, a speech interpreting unit 4, a dialogue control unit 5, a speech output unit 6 (with text-to-speech conversion) and a database 7 with application-specific data. A user's speech inputs are received and transferred to the speech recognition unit 3 via the interface 2. The interface 2 is here a connection to a user particularly over a telephone network. The speech recognition unit 3 based on Hidden Markov Models (HMM) produces a word graph (see FIG. 2) as a recognition result, while in the scope of the invention, however, basically also a processing of one or more N best word sequence hypotheses can be applied. The recognition result is evaluated by the speech understanding unit 4 to determine the relevant syntactic and semantic information in the recognition result produced by the speech recognition unit 3. The speech understanding unit 4 then uses an application-specific grammar which, if necessary, can also access application-specific data stored in the database 7. The information determined by the speech understanding unit 4 is applied to the dialogue control unit 5, which determines herefrom a system response applied to the speech output unit 6, while application-specific data, which are also stored in the database 7, are taken into consideration. When system responses are generated, the dialogue control unit 5 utilizes response samples predefined a priori, whose semantic contents and syntax depend on the information that is determined by the speech understanding unit 4 and transferred to the dialogue control unit 5. Details of the components 2 to 7 may be obtained, for example, from the article by A. Kellner, B. Rüber, F. Seide and B. H. Tran mentioned above.

The speech dialogue system further includes a plurality 8 of speech models LM-0, LM-1, LM-2, . . . , LM-K. The speech model LM-0 here represents a general speech model which was trained to a training text corpus with general theme-unspecific data (for example, formed by texts from daily newspapers). The other speech models LM-1 to LM-K represent theme-specific speech models, which were trained to theme-specific text corpora. Furthermore, the speech dialogue system 1 includes a plurality 9 of databases DB-1, DB-2, DB-M, in which theme-specific information is stored. The theme-specific speech models and the theme-specific databases correspond to each other in line with the respective themes, while one database may be assigned to a plurality of theme-specific speech models. Without detracting from its generality, in the following only two speech models LM-0 and LM-1 and one database DB-1 assigned to the speech model LM-1 are started from.

The speech dialogue system 1 in accordance with the invention is capable of identifying freely formulated meaningful word sub-sequences which are part of a speech input and which are available on the output of the speech recognition unit 3 as part of the recognition result produced by the speech recognition unit 3. Meaningful word sub-sequences are normally represented in dialogue systems by non-terminals (=concept components) and concepts of a grammar.

The speech interpreting unit 4 utilizes a hierarchically structured context-free grammar of which an excerpt is given below.

Grammar excerpt:

<want> ::= I would like to
<want> ::= I would really like to
<number> ::= two

value := 2

<number> ::= three

value := 3

<number> ::= four

value := 4

<tickets> ::= <number>tickets

number := <number>.value

<tickets> ::= <number>tickets

number := <number>.value

<title_phrase>PHRASE(LM-1)

text := STRING
title := RETRIEVE (DB-1ₜᵢₜₗₑ)
contents := RETRIEVE (DB-1_{contents})

<film> ::- <title_phrase>

title := <title_phrase>.title

<film> ::= for <title_phrase>

title := <title_phrase>.title

<book> ::= book
<book> ::= order
<ticket_order> ::= <ticket><film><book>

service := ticket order
number := <tickets>.number
title := <film>.title

<ticket_booking> ::= <film><ticket><book>

service := ticket order
number := <tickets>.number
title := <film>.title

The mark “::=” refers to the definition of a concept or of a non-terminal. The mark “:=” is used for defining an attribute carrying semantic information for a concept or a non-terminal. Such grammar structure is basically known (see the article mentioned above by A. Kellner, B. Rüber, F. Seide, B. H. Tran). An identification of meaningful word sub-sequences is then carried out by means of a top-down parser, while the grammar is used to thus form a concept graph whose arcs represent meaningful word sub-sequences. To the arcs of the concept graph are assigned probability values which are used for determining the best (most probable) path through the concept graph. By means of the grammar is obtained the associated syntactic and/or semantic information for this path, which is delivered to the dialogue control unit 5 as a processing result of the speech understanding unit 4.

For the speech input “I would like to order two tickets for the new James Bond film”, which is a possible word sequence within a word graph delivered by the speech recognition unit 3 to the speech understanding unit 4 (FIG. 2 shows its basic structure), the invention will be explained.

The word sub-sequence “I would like to” is represented by the non-terminal <want>and the word sub-sequence “two tickets” by the non-terminal <tickets>, while this non-terminal in its turn contains the non-terminal <number>which refers to the word “two”. To the non-terminal <number>is again assigned the attribute that describes the respective number value as semantic information. This attribute is used for determining the attribute number, which in its turn assigns as semantic information the respective number value to the non-terminal <tickets>. The word “order” is identified by the non-terminal <book>.

For identifying and interpreting a word sub-sequence lying between two nodes (here between nodes 7 and 12) of the word graph, like here “the new James Bond film”, which cannot be explicitly grasped from a concept or non-terminal of the grammar, the grammar is extended by a new type of non-terminals compared to grammars used thus far, here by the non-terminal <title_phrase>. This non-terminal is used for defining the non-terminal <film>, which in its turn is used for defining the concept <ticket_order>. By means of the non-terminal <title_phrase>, significant word sub-sequences, which contain a freely formulated film title, are identified and interpreted by means of the associated attributes. With a free formulation of a film title one may think of numerous formulation variants which cannot all be predicted. In the present case the correct title is “James Bond—The world is not enough”. The respective word sub-sequence used “the new James Bond film” strongly differs from the correct title of the film; it is not explicitly grasped by the grammar used. Nevertheless, this word sub-sequence is identified as the description of the title. This is realized in that an evaluation is made by means of a plurality of speech models, which are referred to as LM-0 to LM-K in FIG. 1. For the present organization of the dialogue system 1 as a cinema information system, the speech model LM-0 is a general speech model which was trained to a general theme-unspecific text corpus. The speech model LM-1 is a theme-specific speech model which was trained to a theme-specific text corpus, which here contains the (correct) title and short descriptions of all the currently running films. The alternative to this is to grasp word sub-sequences by syntactic rules of the type known thus far (which is unsuccessful for the word sequence such as “the new James Bond film”), so that in the speech understanding unit 4 an evaluation of word sub-sequences is carried out by means of the speech models combined by block 8 i.e. here by the general speech model LM-0 and the speech model LM-1 that is specific of the film title. With the word sub-sequence between the nodes 7 and 12, the speech model LM-1 produces as an evaluation result a probability that is greater than the probability that is produced as an evaluation result by the general speech model LM-0. In this manner the word sub-sequence “the new James Bond film” is identified as the non-terminal <title_phrase>with the variable syntax PHRASE (LM-1). The probability value for the respective word sub-sequence resulting from the acoustic evaluation by the speech recognition unit 3 and the probability value for the respective word sub-sequence produced by the speech model LM-1 are combined (for example, by adding the scores), while preferably heuristically determined weights are used. The resulting probability value is assigned to the non-terninal “title_phrase”.

To the non-terminal <title_phrase>are further assigned three semantic information signals by three attributes text, title and contents. The attribute text refers to the identified word sequence <STRING>as such. The semantic information signals to the attributes title and contents are determined by means of an information search called RETRIEVE, in which the database DB-1 is accessed. The database DB-1 is a theme-specific database in which specific data about cinema films are stored. Under each database entry are stored in separate fields DB-1ₜᵢₜₗₑ and DB-1_{contents}, on the one hand, the respective film title (with the correct reference) and, on the other hand, for each film title a short description (here: “the new James Bond film with Pierce Brosnan as agent 007”). For the attributes title and contents is now determined the database entry that is the most similar to the identified word sub-sequence (it is also possible that a plurality of similar database entries are determined in embodiments) while known search methods are used, for example, an information retrieval method as described in B. Carpenter, J. Chu-Carroll, “Natural Language Call Routing: A Robust, Self-Organizing Approach”, ICSLP 1998. If a database entry has been detected, the field DB-1ₜᵢₜₗₑ is read from the database entry and assigned to the attribute title and also the field DB-1_{contents} with the short description of the film is read and assigned to the attribute contents.

Finally, the thus determined non-terminal <title_phrase>is used for determining the non-terminal <film>.

From the non-terminals interpreted and identified in the above manner, the concept <ticket_ordering>is formed whose attributes service, number and title are assigned the semantic contents of ticket ordering <tickets.number>or <film.title>respectively. The realizations of the concept <ticket_ordering>form part of the concept graph as shown in FIG. 3.

The word graph as shown in FIG. 2 and the concept graph as shown in FIG. 3 are represented in simplified fashion for clarity. In practice the graphs have many more arcs which, however, is unessential to the invention. In the embodiments described above it was assumed that the speech recognition unit 3 delivers a word graph as a recognition result. This, however, is not a must for the invention either. Also a processing of a list N of the best word sequences or sentence hypotheses instead of a word graph is considered. With freely formulated word sub-sequences it is not always necessary to have a database inquiry to determine the semantic contents. This depends on the respective instructions for the dialogue system. Basically, by including additional database fields, any number of semantic information signals that can be assigned to a word sub-sequence can be predefined.

The structure of the concept graph shown in FIG. 3 is given hereinbelow in the form of a Table. The two left columns denote the concept node 5,(boundaries between the concepts). Beside that are the concepts in pointed brackets with associated possible attributes if appropriate plus assigned semantic contents. Corresponding word sub-sequences of the word graph are added in round brackets, which are followed by an English translation or a comment in square brackets if appropriate.

| | | | |
|---|---|---|---|
| 1 | 3 | <want> | [I would like](ich möchte) |
| 1 | 3 | <FILLER> | (Spechte) [sounds like “ich möchte”] |
| 1 | 4 | <want> | [I would really like](ich möchte gerne) |
| 1 | 4 | <FILLER> | (Spechte gerne) |
| | | | [sounds like “ich möchte gerne”] |
| 3 | 4 | <FILLER> | (gerne) |
| 4 | 5 | <FILLER> | (zwei) [two] |
| 4 | 13 | <ticket_order> | (zwei tickets für den neuen James Bond Film |
| | | | bestellen |
| | | | [order two tickets for the new |
| | | | James Bond film] |
| | | service | ticket order |
| | | number | 2 |
| | | title | James Bond - The world is not enough |
| 4 | 13 | <ticket_order> | (drei tickets für den neuen James Bond Film |
| | | | bestellen) |
| | | | [order three tickets for the new James Bond |
| | | | film] |
| | | service | ticket order |
| | | number | 3 |
| | | title | James Bond - The world is not enough |
| 4 | 13 | FILLER | (zwei Trinkgeld den Jim Beam bestellen) |
| | | | [sounds for instant like a correct possible |
| | | | German order of the tickets] |
| 5 | 7 | <bar> | (Trinkgeld) [Aip] |
| | | service | [Aip] |
| 5 | 7 | <FILLER> | (Trinkgeld) [Aip] |
| 7 | 8 | <FILLER> | (den) [the] |
| 8 | 13 | duty_free | (Jim Beam bestellen) [order Jim Beam] |
| | | service | order |
| | | beverage | Jim Beam |
| 8 | 13 | FILLER | (neuen James Beam bestellen) |
| | | | [order new James Beam] |

1. A speech dialogue system (1) comprising a speech understanding unit (4) in which, for identifying a meaningful word sub-sequence from a recognition result produced by a speech recognition unit (3) which result was determined for a word sequence fed to the speech dialogue system (1), the word sub-sequence is evaluated by means of different speech models (8).

2. A speech dialogue system as claimed in claim 1, characterized in that, a general speech model (LM-0) and at least one theme-specific speech model (LM-1, . . . , LM-K) are provided for evaluating the word sub-sequence.

3. A speech dialogue system as claimed in claim 2, characterized in that the plurality of different speech models (8) contains at least one theme-specific speech model (LM-1, . . . , LM-K) to which a database (DB-1, . . . , DB-M) with respective theme-specific data material is assigned, which material is used for determining the semantic information contained in the word sub-sequence.

4. A method of extracting a significant word sub-sequence from a recognition result produced by a speech recognition unit (3) of a speech dialogue system (1), in which the word sub-sequence is evaluated with different speech models (8) in a speech understanding unit (4) of the speech dialogue system (1).
